(19) United States
(12) Patent Application Publication
(10) Pub. No.: US 2021/0048151 A1
(43) Pub. Date: Feb. 18, 2021

(54) EDGE-LIT PLATE-FORM LAMP

(71) Applicant: XIAMEN ECO LIGHTING CO. LTD., Xiamen (CN)

(72) Inventors: Yizhen Chen, Xiamen (CN); Yongzhe Dong, Xiamen (CN); Xiaoliang Wen, Xiamen (CN); Shouqiang Hou, Xiamen (CN); Qiao rong Chen, Xiamen (CN)

(21) Appl. No.: 16/543,501

(22) Filed: Aug. 16, 2019

(51) Int. Cl. F21K 9/235; F21V 23/04; F21V 17/08

(52) U.S. Cl. CPC F21K 9/235; F21V 17/08; F21V 23/04

(57) ABSTRACT

An edge-lit plate-form lamp includes a plate-form bottom casing, a plate-form top casing, an illuminating component and a plug. The plate-form bottom casing has a cavity disposed within. The plate-form top casing detachably engages with the bottom casing. The plate-form top casing includes a window. The illuminating component is disposed within the cavity. The window allows light emission from the illuminating component within an emission area defined by the window. The plug extends across the plate-form bottom casing. Also, the plug is electrically coupled to the illuminating component. In addition, the plug relays power to the illuminating component while being electrically coupled to an external power source.

### BACKGROUND OF THE INVENTION

### 1. Field of the Invention

The present invention relates to an edge-lit lamp, and more particularly, to an edge-lit lamp in a form of a plate.

### 2. Description of the Prior Art

A conventional edge-lit lamp has a complicated structure for meeting various functional requirements. However, such complexity in structure leads to a higher fabrication cost and a lower error-tolerance rate. In addition, such conventional edge-lit lamp may still be limited by its luminance adjusting capability. That is, such conventional edge-lit lamp only provides a switch-on function and a switch-off function without giving any flexibility in dynamic adjustment of luminance. Also, because of the abovementioned complexity, the conventional edge-lit lamp inevitably occupies a large volume and is difficult to be designed in a portable manner.

### SUMMARY OF THE INVENTION

The present invention aims at providing an edge-lit lamp having a small volume, flexibility in adjusting luminance, and portability.

In this way, the present invention discloses an edge-lit plate-form lamp. The edge-lit plate-form lamp includes a plate-form bottom casing, a plate-form top casing, an illuminating component and a plug. The plate-form bottom casing has a cavity disposed within. The plate-form top casing detachably engages with the bottom casing. The plate-form top casing includes a window. The illuminating component is disposed within the cavity. The window allows light emission from the illuminating component within an emission area defined by the window. The plug extends across the plate-form bottom casing. Also, the plug is electrically coupled to the illuminating component. In addition, the plug relays power to the illuminating component while being electrically coupled to an external power source.

In one example, the illuminating component includes a light source, a proximity sensor and a control circuit board. The light source emits lights of the illuminating component. The proximity sensor senses proximity of an object to itself. The control circuit board is electrically coupled to the light source and the proximity sensor. Also, the control circuit board powers up the light source and adjusts an amplitude of the lights emitted by the light source according to the object's proximity to the proximity sensor.

In one example, the control circuit board increases the amplitude of the lights emitted by the light source when the object's proximity to the proximity sensor increases. The control circuit board also decreases the amplitude of the lights emitted by the light source when the object's proximity to the proximity sensor decreases.

In one example, the control circuit board switches on the light source when the object's proximity to the proximity sensor is within a critical distance from the proximity sensor.

In one example, the control circuit board switches off the light source when the object's proximity to the proximity sensor is outside a critical distance from the proximity sensor.

In one example, the edge-lit plate-form lamp further includes a light guide. The light guide is disposed between the plate-form top casing and the illuminating component. Also, the light guide directs the lights emitted from the illuminating component to the emission area defined by the window.

In one example, the light guide includes a reflector, a light guiding element and a light transmitting component. The reflector is disposed between the plate-form top casing and the illuminating component. Also, the reflector filters off a portion of the lights emitted from the illuminating component by reflection. The light guiding element is disposed between the plate-form top casing and the reflector. In addition, the light guiding element concentrates the lights that are emitted from the illuminating component but failed to be filtered off by the reflector. The light transmitting component is disposed between the plate-form top casing and the light guiding element. Moreover, the light transmitting component allows the concentrated lights to reach the emission area.

In one example, the light transmitting component includes a base plate and an upper light transmitting plate. The base plate has a lateral side propped by an internal wall of the plate-form top casing in a way that the base plate is affixed within the cavity. The upper light transmitting plate covers the base plate in an attached manner and to fit the window.

In one example, the base plate and the upper light transmitting plate are fabricated in an integrated manner. Both the base plate and the upper light transmitting plate are fabricated using a light transmitting material.

In one example, the upper light transmitting plate includes an opal optical polycarbonate (PC) plate or an opal polystyrene (PS) plate.

In one example, the reflector includes a reflective paper.

In one example, a thickness of the reflective paper is substantially between 0.1 millimeter (mm) and 0.5 mm.

In one example, the light guiding element may include a poly(methyl methacrylate) (PMMA) plate, a polycarbonate (PC) plate, a silk screen dot printing plate, or a laser dot plate.

In one example, the edge-lit plate-form lamp further includes a holding plate, which is disposed within the cavity. The holding plate also holds the illuminating component.

In one example, the light transmitting component includes a base plate. The base plate has a lateral side propped by an internal wall of the plate-form top casing in a way that the base plate is affixed within the cavity. The base plate includes a first engaging element. The holding plate includes a second engaging element. The first engaging element and the second engaging element detachably engage with each other such that the light transmitting plate is capable of detachably engaging with the holding plate.

In one example, the first engaging element and the second engaging element are detachably engaged with each other via a snap fit, a threaded fit, an interference fit, a tongue-and-groove fit, a post-and-bore fit, or a press fit.

In one example, one of the first engaging element and the second engaging element is a pillar, whereas the other one is a hole capable of receiving the pillar.

In one example, the window, the reflector, a light guiding element and the light transmitting element share a same geometric shape.

In one example, the geometric shape is a rectangle.

In one example, the plate-form top casing detachably engages with the plate-form bottom casing via a snap fit, a threaded fit, an interference fit, a tongue-and-groove fit, a post-and-bore fit, or a press fit.

In one example, the plate-form bottom casing includes a concave bottom surface and a protruded bottom surface. The edge-lit plate-form lamp further attaches to an external flat surface at a first lateral side of the edge-lit plate-form lamp. The concave bottom surface is closer to the first lateral side than the protruded bottom surface.

In one example, the edge-lit plate-form lamp further includes a switch. The switch is disposed on a through hole formed between the plate-form top casing and the plate-form bottom casing. Also, the switch is electrically coupled to the illuminating component. In addition, the switch switches on or switches off the illuminating component according to a command received by the switch.

In one example, the switch includes a toggle switch or a stepless switch.

In one example, the edge-lit plate-form lamp further includes a regulator. The regulator is disposed on and electrically coupled to a control circuit board of the illuminating component. Also, the regulator controls luminance of the illuminating component according to the command.

In one example, the plug is integrated to the plate-form bottom casing by plastic molding.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a topside view of an edge-lit plate-form lamp according to one example of the present invention.

FIG. 2 illustrates a backside view of the edge-lit plate-form lamp according to one example of the present invention.

FIG. 3 illustrates an exploded view of the edge-lit plate-form lamp according to one example of the present invention.

### DETAILED DESCRIPTION

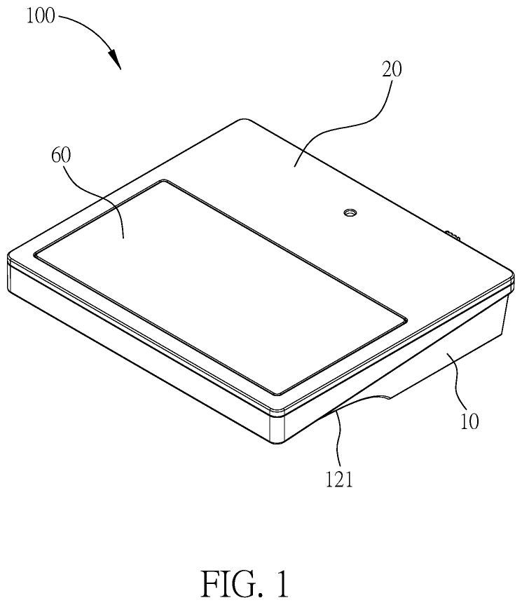

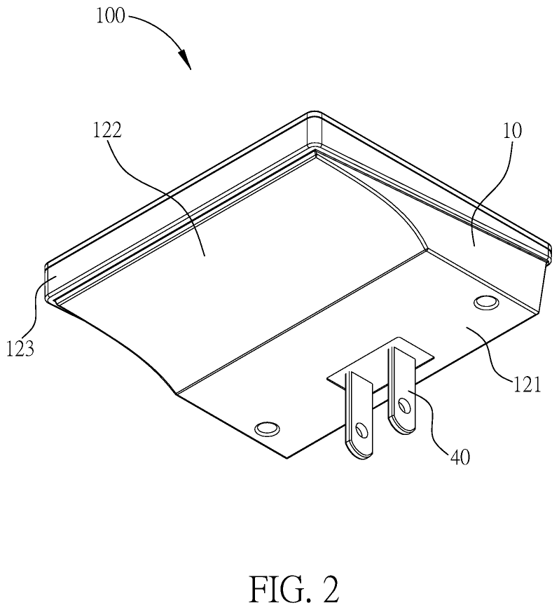

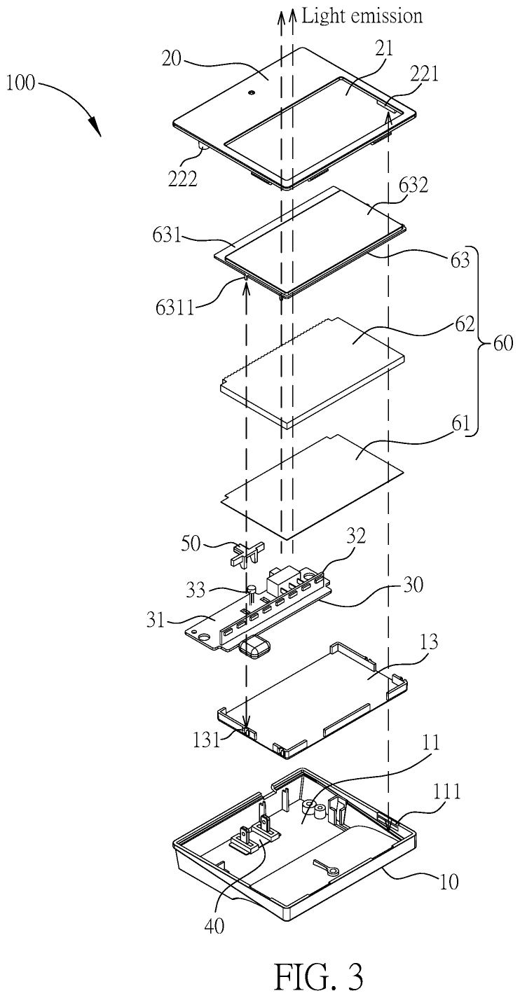

As mentioned above, the present invention discloses an edge-lit plate-form lamp for overcoming defects of a conventional edge-lit lamp. Please refer to FIGS. 1-3, which illustrate an edge-lit plate-form lamp 100 according to one embodiment of the present invention. More particularly, FIG. 1 illustrates a topside view of the edge-lit plate-form lamp 100. FIG. 2 illustrates a backside view of the edge-lit plate-form lamp 100. And FIG. 3 illustrates an exploded view of the edge-lit plate-form lamp 100.

The edge-lit plate-form lamp 100 primarily includes a plate-form bottom casing 10, a plate-form top casing 20, an illuminating component 30 and a plug 40.

The plate-form bottom casing 10 includes a cavity 11 that is disposed within the plate-form bottom casing 10. The plate-form top casing 20 may detachably engage with the plate-form bottom casing 10. Also, the plate-form top casing 20 includes a window 21.

The illuminating component 30 is disposed within the cavity 11. The window 11 allows lights emitted from the illuminating component 30 to fall within an emission area defined by the window 21.

The plug 40 extends across the plate-form bottom casing 10. Also, the plug 40 is electrically coupled to the illuminating component 30. In addition, when the plug 40 is electrically coupled to an external power source outside the edge-lit plate-form lamp 100, the plug 40 may relay power to the illuminating component 30.

Specifically, both the plate-form bottom casing 10 and the plate-form top casing 20′ shapes are crucial. Such plate-form shape leads to a smaller volume of the edge-lit plate-form lamp 100, and moreover, a lighter weight, a simpler structure, better portability, and easy installation. The edge-lit plate-form lamp 100 may be installed on a wall at its lateral side for exploiting the abovementioned advantages.

In addition, since the illuminating component 30 is disposed within the cavity 11, lights emitted from the illuminating component 30 can be focused on the emission area defined by the window 21 in a more distributed manner, such that the emission area may give a smoother vision to anyone who uses the edge-lit plate-form lamp 100.

In one example, the illuminating component 30 includes a light source 32, a control circuit board 31, and a proximity sensor 33. The light source 32 emits lights of the illuminating component 30. The proximity sensor 33 may sense an object's proximity to itself for determining the light source 32's on/off status and/or luminance. The control circuit board 31 is electrically coupled to the light source 32 and the proximity sensor 33. Also, the control circuit board 31 powers up the light source 32 and adjusts an amplitude of the lights emitted by the light source 32 according to the object's proximity to the proximity sensor 33. For example, when the proximity sensor 33 senses a larger proximity of an object to the proximity sensor 33, i.e., closer to the proximity sensor 33, the control circuit board 31 may increase the amplitude of the lights emitted by the light source 32. Similarly, when the proximity sensor 33 senses a smaller proximity of an object to itself, i.e., farer from the edge-lit plate-form lamp, the control circuit board 31 may decrease the amplitude of the lights emitted by the light source 32. In this way, the light source 32 increases its luminance when a sensed object is getting closer. And the light source 32 also decreases its luminance when the sensed object is getting farer. In still another example, when the proximity sensor 33 senses at least one object that located within its proximity, i.e., closer than a critical distance from itself (i.e., from the edge-lit plate-form lamp 100), the control circuit board 31 switches on the light source 32 in response. Similarly, when the proximity sensor 33 fails to sense at least one object that located within its proximity, i.e., farer than the critical distance from itself (i.e., from the edge-lit plate-form lamp 100), the control circuit board 31 switches off the light source 32 in response. A length of the critical distance depends on the proximity sensor 33's sensing capability. As a result, the edge-lit plate-form lamp 100 may avoid undesired power consumption by dynamically adjusting the light source 32's on/off status and/or luminance.

In one example, the edge-lit plate-form lamp 100 further includes a light guide 60, which is disposed between the plate-form top casing 20 and the illuminating component 30. The light guide 60 may aid in directing lights emitted from the illuminating component 30 to the window 21. In one example, the light guide 60 includes a reflector 61, a light guiding element 62 and a light transmitting component 63. As shown in FIG. 3, the reflector 61, the light guiding element 62 and the light transmitting component 63 are disposed sequentially from the illuminating component 30 to the plate-form top casing 20. The reflector 61 may filter off a portion of the lights emitted from the illuminating component 30 by reflection. In one example, the reflector 631 is fabricated using a reflective paper with a thickness of, for example, substantially between 0.1 millimeter (mm) and 0.5 mm. The light guiding element 62 may concentrate the lights that are emitted from the illuminating component 30 but failed to be filtered off by the reflector 61. In one example, the light guiding element 62 is fabricated using a poly(methyl methacrylate) (PMMA) plate, a polycarbonate (PC) plate, a silk screen dot printing plate, or a laser dot plate. The light transmitting component 63 may allow the concentrated lights from the light guiding element 62 to reach the emission area defined by the window 21.

More specifically, in one example, the light transmitting component 63 includes a base plate 631 and an upper light transmitting plate 632. The base plate 631 has a lateral side propped by an internal wall 222 of the plate-form top casing 20 in a way that the base plate 631 is affixed within the cavity 11. With the aid of the internal wall 222, the upper light transmitting plate 632 can be aligned with the window 21 without deviation. Also, since a lower side of the base plate 631 can be well seated within the cavity 11, the light transmitting component 63 is sandwiched between the cavity 11 and the plate-form top casing 20 in an affixed manner. In addition, both the reflector 61 and the light guiding element 62 are also affixed because of the affixed light transmitting component 63.

The upper light transmitting plate 632 may cover the base plate 631 in an attached manner and to fit the window 21. In one example, the upper light transmitting plate 632 is fabricated using an opal optical polycarbonate (PC) plate or an opal polystyrene (PS) plate.

In one example, the base plate 631 and the upper light transmitting plate 632 are fabricated in an integrated manner. And both the base plate 631 and the upper light transmitting plate 632 are fabricated using a light transmitting material.

In one example, the edge-lit plate-form lamp 100 also includes a holding plate 13 disposed within the cavity 11. The holding plate 13 may hold the illuminating component 30. In one example, the base plate 631 may detachably engage with the holding plate 13, such that the light transmitting plate 60 is capable of detachably engaging with the holding plate 13. In one example, the base plate 631 has a first engaging element, and the holding plate 13 has a first engaging element, such that the base plate 631 detachably engages with the holding plate 13 via detachable engagement between the first engaging element and the second engaging element. In one example, the first engaging element is a receiving hole 131, and the second engaging element is a pillar 6311 that can be received by the receiving hole 131 for detachably engaging. In some examples, the detachable engagement between the base plate 631 and the holding plate 13 may be implemented via a snap fit, a threaded fit, an interference fit, a tongue-and-groove fit, a post-and-bore fit, or a press fit.

In some examples, for better focusing lights emitted from the illuminating component 30 to fall within the emission area defined by the window 21, the window 21, the reflector 61, the light guiding element 62 and the light transmitting element 63 share a same geometric shape, for example, a rectangle.

In some examples, the plate-form top casing 20 detachably engages with the plate-form bottom casing 10 via a snap fit, a threaded fit, an interference fit, a tongue-and-groove fit, a post-and-bore fit, or a press fit. For example, the plate-form top casing 20 may include a tongue 221, and the plate-form bottom casing 10 may include a groove 111. In addition, the tongue 221 may detachably engage with the groove 111, such that the plate-form top casing 20 detachably engages with the plate-form bottom casing 10. Similarly, the plate-form top casing 20 may also include a groove, and the plate-form bottom casing 10 may include a tongue that is detachably engageable with the groove, such that the plate-form top casing 20 detachably engages with the plate-form bottom casing 10.

As mentioned before, the edge-lit plate-form lamp 100 may be installed on a wall, i.e., an external flat surface, by attaching its sidewall to the external flat surface. For a more convenient usage while applying the sidewall installation, the plate-form bottom casing 10 includes a concave bottom surface 121 and a protruded bottom surface 122, as shown in FIGS. 1-2. In addition, a sidewall 123 of the plate-form top casing 20, which is closer to the concave bottom surface 121 than the protruded bottom surface 122, is attached to the external flat surface for installation. In this way, a user may attach or detach the edge-lit plate-form lamp 100 to or from the external flat surface in an easier manner when he or she reaches his/her hands to the concave bottom surface 121, with the aid of a space formed between the external flat surface and the concave bottom surface 121 that is convenient for hand-reaching.

In one example, the edge-lit plate-form lamp 100 may further include a switch 50, which is disposed on a through hole (at a backside of the edge-lit plate-form lamp 100 and invisible in FIGS. 1-3) formed between the plate-form top casing 20 and the plate-form bottom casing 10. The switch 50 is electrically coupled to the illuminating component 30 for switching on or switching off the illuminating component 30 via a command received by the switch 50, for example, a manual flip on the switch.

In some examples, the switch 50 is a toggle switch or a stepless switch.

In one example, the edge-lit plate-form lamp 100 further includes a regulator (not shown), which is disposed on and electrically coupled to the control circuit board 31. Also, the regulator is electrically coupled to the switch for manipulation. In this way, the regulator is capable of controlling luminance of the illuminating component 30 according to a command received by the switch 50, for example, a manual operation exerted on the switch 50. And luminance of the illuminating component 30 can thus be dynamically adjustable.

In one example, the plug 40 is integrated to the plate-form bottom casing 10 by plastic molding. Such that the plug 40 acquires a stronger connection with the plate-form bottom casing 10 and prevents itself from falling off the plate-form bottom casing 10 easily.

Those skilled in the art will readily observe that numerous modifications and alterations of the device and method may be made while retaining the teachings of the invention. Accordingly, the above disclosure should be construed as limited only by the metes and bounds of the appended claims.

1. An edge-lit plate-form lamp, comprising:
a plate-form bottom casing, having a cavity disposed therein;
a plate-form top casing, configured to detachably engage with the plate-form bottom casing, wherein the plate-form top casing comprises a window;
an illuminating component, disposed within the cavity, wherein the window is configured to allow light emission from the illuminating component to emit within an emission area defined by the window; and
a plug, configured to extend across the plate-form bottom casing, electrically coupled to the illuminating component, and configured to relay power to the illuminating component while being electrically coupled to an external power source, wherein the illuminating component comprises:
a light source, configured to emit light;
a proximity sensor, configured to sense proximity of an object to the proximity sensor; and
a control circuit board, electrically coupled to the light source and the proximity sensor, and configured to power the light source and adjust an amplitude of the lights emitted by the light source according to the object's proximity to the proximity sensor, wherein the control circuit board is further configured to increase the amplitude of the lights emitted by the light source when the object's proximity to the proximity sensor increases; and
wherein the control circuit board is further configured to decrease the amplitude of the lights emitted by the light source when the object's proximity to the proximity sensor decreases.

2. (canceled)

3. (canceled)

4. The edge-lit plate-form lamp of claim 1, wherein the control circuit board is further configured to switch on the light source when the object's proximity to the proximity sensor is within a critical distance from the proximity sensor; and
wherein the control circuit board is further configured to switch off the light source when the object's proximity to the proximity sensor is outside a critical distance from the proximity sensor.

5. The edge-lit plate-form lamp of claim 1, further comprising:
a light guide, disposed between the plate-form top casing and the illuminating component, and configured to direct the lights emitted from the illuminating component to the emission area defined by the window.

6. The edge-lit plate-form of claim 5, wherein the light guide comprises:
a reflector, disposed between the plate-form top casing and the illuminating component;
a light guiding element, disposed between the plate-form top casing and the reflector; and
a light transmitting component, disposed between the plate-form top casing and the light guiding element, and configured to allow the concentrated lights to reach the emission area.

7. The edge-lit plate-form lamp of claim 6, wherein the light transmitting component comprises:
a base plate, having a lateral side propped by an internal wall of the plate-form top casing in a way that the base plate is affixed within the cavity; and
an upper light transmitting plate, configured to cover the base plate in an attached manner and to fit the window.

8. The edge-lit plate-form lamp of claim 7, wherein the base plate and the upper light transmitting plate are fabricated in an integrated manner, and both the base plate and the upper light transmitting plate are fabricated using a light transmitting material.

9. The edge-lit plate-form lamp of claim 7, wherein the upper light transmitting plate comprises an opal optical polycarbonate (PC) plate or an opal polystyrene (PS) plate.

10. The edge-lit plate-form lamp of claim 6, wherein the reflector comprises a reflective paper.

11. The edge-lit plate-form lamp of claim 10, wherein a thickness of the reflective paper is substantially between 0.1 millimeter (mm) and 0.5 mm.

12. The edge-lit plate-form lamp of claim 6, wherein the light guiding element comprises a poly (methyl methacrylate) (PMMA) plate, a polycarbonate (PC) plate, a silk screen dot printing plate, or a laser dot plate.

13. The edge-lit plate-form lamp of claim 6, further comprising:
a holding plate, disposed within the cavity, and configured to hold the illuminating component.

14. The edge-lit plate-form lamp of claim 13, wherein the light transmitting component comprises:
a base plate, having a lateral side propped by an internal wall of the plate-form top casing in a way that the base plate is affixed within the cavity, wherein the base plate comprises a first engaging element;
wherein the holding plate comprises a second engaging element; and
wherein the first engaging element and the second engaging element are configured to detachably engage with each other, such that the light transmitting plate is capable of detachably engaging with the holding plate.

15. The edge-lit plate-form lamp of claim 14, wherein the first engaging element and the second engaging element are detachably engaged with each other via a snap fit, a threaded fit, an interference fit, a tongue-and-groove fit, a post-and-bore fit, or a press fit.

16. The edge-lit plate-form lamp of claim 15, wherein one of the first engaging element and the second engaging element is a pillar, whereas the other one is a hole capable of receiving the pillar.

17. The edge-lit plate-form lamp of claim 6, wherein the window, the reflector, the light guiding element and the light transmitting element share a same geometric shape.

18. The edge-lit plate-form lamp of claim 17, wherein the geometric shape is a rectangle.

19. The edge-lit plate-form lamp of claim 1, wherein the plate-form top casing is configured to detachably engaged with the plate-form bottom casing via a snap fit, a threaded fit, an interference fit, a tongue-and-groove fit, a post-and-bore fit, or a press fit.

20. (canceled)

21. The edge-lit plate-form lamp of claim 1, further comprising:
a switch, disposed on a through hole formed between the plate-form top casing and the plate-form bottom casing, electrically coupled to the illuminating component, and configured to switch on or switch off the illuminating component according to a command received by the switch.

22. The edge-lit plate-form lamp of claim 21, further comprising:
a regulator, disposed on and electrically coupled to a control circuit board of the illuminating component, electrically coupled to the switch, and configured to control luminance of the illuminating component according to the command.

23. The edge-lit plate-form lamp of claim 21, wherein the switch comprises a toggle switch or a stepless switch.

24. The edge-lit plate-form lamp of claim 1, wherein the plug is integrated to the plate-form bottom casing by plastic molding.
